(19) United States
(12) Patent Application Publication
(10) Pub. No.: US 2013/0326357 A1
(43) Pub. Date: Dec. 5, 2013

(54) INTERACTIVE BRANDING AND ADVERTISING USING DYNAMIC USER INPUT

(71) Applicant: Brand2Mind, Inc., (US)

(72) Inventors: James O'Donnell, Mill Valley, CA (US); James R. Newcomb, La Jolla, CA (US); Thomas C. Kuhn, III, La Jolla, CA (US)

(21) Appl. No.: 13/791,785

(22) Filed: Mar. 8, 2013

Related U.S. Application Data
(60) Provisional application No. 61/608,540, filed on Mar. 8, 2012.

(51) Int. Cl. G06F 21/60; G06F 3/0484; G06F 17/30

(52) U.S. Cl. CPC G06F 21/60; G06F 17/30424; G06F 3/0484
USPC 715/741; 707/769; 726/27

(57) ABSTRACT

A system adapted to manage user access to media content is described. The system includes: a communication module adapted to receive a user request to access content; a verification engine communicatively coupled to the communication module, the verification engine adapted to provide a query to a user and receive an associated response; and a content gateway communicatively coupled to the verification engine and the communication module, the content gateway adapted to provide content to the user if the verification engine determines that the response satisfies the query. An automated method adapted to control user access to web-based content includes: identifying a user interaction; providing a branding request; receiving a response to the request; and providing access to the content if the response matches a set of evaluation criteria. A graphical user interface (GUI) allows efficient implementation of the automated method and use of the system.

### CROSS-REFERENCE TO RELATED APPLICATIONS

This application claims priority to U.S. Provisional Patent Application Ser. No. 61/608,540, filed on Mar. 8, 2012.

### BACKGROUND

Today a majority of internet and mobile advertisements (or “ads”) are driven by passive promotions requiring virtually no interaction with the targeted consumer who is engaging with the brand messaging. In addition, the primary motivators for branding initiatives are driven by the ability of the ads to: (1) build brand awareness, and/or (2) brand recognition resulting in an uptake of the brands products or services by the targeted consumer. The major types of internet advertising at this time include: banner ads, text ads including contextual ads, interstitials, pop-up ads, opt-in mailing, Hypertext Mark-up Language (“HTML”) ads, rich media ads, hybrid ads and sponsorships/partnership promotions.

HTML and Extensible Mark-up Language (“XML”) are common languages (or “codes”) that are used in web page design, creation and implementation. HTML is considered the main “mark-up” language and is used in part to provide text-based instructions that describe the particular layout of the web page. XML is another mark-up language that provides set of rules for encoding documents as well as web services. In addition, a Web page can be divided into subpages (using frames, an HTML extension). HTML and XML can be used to create “links or hyperlinks” in order to link any information to any other information over the Internet or the World Wide Web by targeting a hypertext or link within a given document or web page.

The enormous revenue potential of the Internet and the monetization of the web sites and their contents are linked proportionally to the traffic of unique users that reach, view and engage those web sites. A hit, visit or engagement by a user to a commercial web site and its content has potential for monetization and revenue generation.

In order to monetize and generate revenue, most Internet businesses use interrupting and disruptive advertisements such as pop-up windows (including contextual videos and text), or space consuming advertisements such as banner advertisements, link exchanges, and banner exchanges. Internet businesses also use bulk e-mail or “spam” to advertise. The ultimate goal of these advertisements and the methods used to deliver them to the end user are to increase consumer awareness or recognition of a brand.

These interrupting advertisements can only guarantee presentation to a user but the presentation and the length of presentation is minimal, as most users find these interrupting advertisements annoying and intrusive and simply close the window or navigate away from the web site rather than actively engaging these types of advertisement. Passive or impression advertisements are space consuming advertisements that are ubiquitous and they have virtually become “white noise” on a web page. These advertisements don't allow for any engagement by the users and are often ignored. Alternative advertising methods are similarly problematic.

Contextual video and text, utilizing “pop-up” windows, generates a separate window that is displayed “on top” or “in front,” disrupting the current web page being viewed by the user. The advertisement, which may be of any size, as defined by the web site developer, is displayed in a new browser window and may contain text, video, picture, etc. Pop-up windows are considered highly disruptive and annoying by the end users who are ultimately the potential customers.

Banner advertisements, other impression or static advertisements that are space consuming, provide display advertisement as well as a link to the advertiser's own web site. These impression advertisements have saturated the web pages, and they are losing their effectiveness. The consumer is less likely to “engage” these forms of advertisement because the advertisements have become too pervasive and the users have become desensitized over time.

Click-through-ratio or CTR measures the effectiveness of internet advertising and its presentation methods. CTR measures the ratio of the number of times a given advertisement is displayed and the number of times that advertisement is actively engaged by the user in order to “click through” to the advertised site. This is a measure of user engagement with the advertising and impression based advertising methods that are losing their effectiveness.

Bulk or “spam” e-mail is an alternative advertising method that most potential customers find unfavorable. Most potential customers screen the messages as Spam and the messages are deleted unopened and unread.

The immediate problems with these existing advertisement formats on both the internet and in mobile centric applications include but are not limited to: (1) that they are intrusive, annoying and distracting, (2) they consume anywhere from 10% to 40% of existing display space on phones, tablets and PCs leaving less room for meaningful content to be displayed, (3) they require limited to no involvement by the consumer who is engaged with the message—for the most part these ads are passive where the consumer is only a viewer, (4) the ads do not contain mechanisms that cause an increase in brand awareness or retention since the ads are passive and non-interactive as far as requiring a consumer to participate in the ad, (5) for those who provide content or access to data, services etc. the providers are faced with virtually only two venues, (a) utilize a pay wall and charge the consumer for access and/or (b) give the content away for free.

Therefore there exists a need for a scheme that allows for active consumer engagement with an ad and where an advertiser is assured of mentally imprinting and interacting the advertiser's brand messaging at a far deeper psychological and physiological level which cannot be achieved via other forms of passive view advertising.

### BRIEF SUMMARY

In addition to its use in creating web pages, HTML, XML and other codes can be used to create advertising for the Internet. The developer or publisher of a web site can strategically insert HTML, XML or other codes in their web pages so that when potential customers view the web page, an advertisement, a link to another web site or both is displayed for the user to view and/or select.

Additionally, scripting or extension languages, including but not limited to, JavaScript, VBScript, XUL, XSLT or PERL are used to enhance the capabilities of Web pages. Scripting languages can include Application Programming Interfaces (“APIs”) that are designed to define and track user behavior. User choices and actions are then stored on a user's computer, hand held device and/or other computing machines on the user's side or on the web page developer, web page publisher, or the advertiser's servers that will then be used to identify key features about the user including preferences, demographics and behaviors based on psychographic databases.

Utilizing the scripting or extension languages, web site developers and Internet advertisers often place a text file or “cookie” on the user's hard disc when the user visits a web site. These cookies can then be used by the web site developers, publishers and advertisers to track and monitor the user's behavior on the web.

Some embodiments provide a method of accessing desired premium content such that the engagement of the consumer with the brand is viewed more positively by the content consumer because it is an enabler rather than an obstruction to gaining access to premium content. Such premium content may include content that is typically only available to subscribers or other paid users (i.e., content that is not available to the general public).

The interactive dynamics stated above make this content key system more valuable to brand advertisers than other forms of advertising media. The process of the consumer having an interactive engagement with the brand generates significantly higher brand recall and retention rates than are currently available through the passive ad options now employed. The interactive dynamics also provide a favorable experience for the users who gain access to content that was otherwise inaccessible.

Some embodiments of the present invention may provide a marketing system and method using embedded software having an embedded window frame presented to a subscriber/user after a hyperlink or search field is accessed. Some embodiments may include data processing, content unlocking, and marketing data collection capabilities provided through a graphical user interface (“GUI”) running on an appropriate user device (e.g., a personal computer, a mobile device, a tablet device, etc.).

One example embodiment of the invention provides a system adapted to manage user access to media content. The system includes: a communication module adapted to receive a user request to access content; a verification engine communicatively coupled to the communication module, the verification engine adapted to provide a query to a user and receive an associated response; and a content gateway communicatively coupled to the verification engine and the communication module, the content gateway adapted to provide content to the user if the verification engine determines that the response satisfies the query.

Another example embodiment of the invention provides an automated method adapted to control user access to web-based content. The method includes: identifying a user interaction; providing a branding request to the user; receiving a response to the request; and providing access to the content if the response matches a set of evaluation criteria.

A third example embodiment of the invention provides a non-volatile storage medium comprising sets of instructions that, when executed by a processing device, provide a graphical user interface (GUI) adapted to facilitate access to premium content. The GUI includes: a listing of brands comprising a set of selectable elements, each selectable element comprising at least one graphical display element and at least one text-based phrase; a brand entry feature associated with at least selectable element, the brand entry feature adapted to receive a text-based user entry; and a confirmation feature adapted to allow a user to proceed to the premium content based at least partly on the text-based user entry.

The preceding Summary is intended to serve as a brief introduction to some embodiments of the invention. It is not meant to be an introduction or overview of all inventive subject matter disclosed in this document. The Detailed Description that follows and the Drawings (or “Figures” or “FIGS.”) that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matter is not to be limited by the illustrative details in the Summary, Detailed Description and the Drawings, but rather is to be defined by the appended claims, because the claimed subject matter may be embodied in other specific forms without departing from the spirit of the invention.

### BRIEF DESCRIPTION OF THE DRAWINGS

The novel features of the invention are set forth in the appended claims. However, for purpose of explanation, several embodiments of the invention are set forth in the following drawings.

FIG. 1 illustrates a schematic block diagram of a conceptual system provided by some embodiments;

FIG. 2 illustrates a schematic block diagram of a conceptual software system provided by some embodiments;

FIG. 3 illustrates a conceptual flow chart of a user engagement process of some embodiments of the present invention;

FIG. 4 illustrates a conceptual flow chart of a user branding process of some embodiments;

FIG. 5 illustrates a conceptual flow chart of a mobile download and account setup process of some embodiments;

FIG. 6 illustrates a conceptual flow chart of a default account setup process of some embodiments;

FIGS. 7A-7D illustrate a set of example GUIs provided by some embodiments; and

FIG. 8 conceptually illustrates a schematic block diagram of a computer system with which some embodiments of the invention may be implemented

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

The embedded window frame of some embodiments may include a list of brand-centric information including: corporate images, trademarks, logos, icons, product names, associated product or services, and/or corporate centric slogans. Options for selection may be presented to the user through prompts for typing a slogan in as a text input, clicking the slogan, dragging and dropping the slogan, or posting an audiovisual image. Such selection may allow a user to unlock website content, obtain search privileges, etc.

The embedded window frame may have slogans grouped into a single list and the list may be presented in an alternating or cyclic fashion for collection of a user's input. Some embodiments may require a subscriber or user to provide input in the form of typed text, a voice, and/or video file. A selection button, video key, or kinetic move may allow entry of choices from a choice list built within the embedded software in the website window frame. Some embodiments may allow the user to select one or more items and type the slogan from the organized list in order to unlock the content.

By having the content subscriber read and actually input a brand slogan, the subscriber may be assured of mentally imprinting and interacting with the brand messaging at a far deeper psychographic level than can be achieved via other forms of passive view advertising (e.g. banner ads and commercials).

Some embodiments provide a way to: (1) lock (i.e., close) digital content from open access by a digital user or subscriber and (2) unlock the digital content though the physical input of a dynamic brand key that enables users or subscribers with privileges to access and utilize specified digital content based on each user's or subscriber's interactive engagement with the system's rule based queries. Digital content may include various data elements that are able to be provided to a user in a digital form (e.g., text-based content, audio content, video content, audiovisual content, etc.). Such content may be provided using various appropriate ways (e.g., through one or more web sites and/or web pages, using various combinations of client-side user device applications, server-side applications, and/or other resources (e.g., user device storage, server storage, communication pathways or protocols, etc.).

Some embodiments may interactively lock (i.e., protect) and/or unlock (i.e., open) digital property access based on provision of a dynamic brand key via a user device and gaining operation privileges to execute actions such as search, copy, and/or paste, and/or to access a database based on the provided keys. The unlocking of the content is driven by an end-user act generating a cost per action (“CPA”). Some embodiments allow monetization of key words such as brands, brand attributes and marketing related directives.

Some embodiments may assist digital property owners, publishers, and/or aggregators with protecting their intellectual property from unrestricted access and may provide a methodology and process for use by the owners, publishers, and/or aggregators to monetize their properties.

The system of some embodiments may include a methodology that locks access to content from any users or subscribers that have not successfully gained access privileges. The system may utilize a content blocking algorithm that prohibits viewing or access to “locked down” content or sites.

Subscribers or users interested in viewing or accessing digital property enabled with the system of some embodiments may receive a brand-centric dynamic prompt or query over a computer network. The brand-centric prompt or query may be organized so as each rule set presented by the system will require the subscriber or user to input brand specific information into the system via some appropriate input device (e.g., a keyboard, mouse, mobile phone key pad, touch screen, natural user interface (“NUI”), microphone, camera, etc.).

The brand-centric prompt or query may be in the form or a brand slogan, brand tagline, brand motto, brand saying, product name etc. The prompt or query may be introduced to the subscriber/user by opening a window frame (or other appropriate user interface element) which presents both a random and pre-determined rule set that requires the interactive input of the subscriber or user to unlock the desired content or site access.

The system of some embodiments may “learn” the likes, dislikes (i.e., preferences), location, and history of the subscriber or user so as to provide personalized brand-centric rule sets that maximize the impact of the branding message over time.

The system may select and deliver relevant “brand keys” to the subscriber or user. The system may incorporate a set of dynamic brand rule sets that may be served to the subscriber or user based on, for instance, geographic location. The system may thus enable the deployment of third party applications which provide brand-centric product and service initiatives.

Several more detailed embodiments of the invention are described in the sections below. Section I provides a conceptual description of a system used by some embodiments. Section II then describes various methods of operation used by some embodiments. Next, Section III describes various example GUIs provided by some embodiments. Lastly, Section VII describes a computer system which implements some of the embodiments of the invention.

### I. System

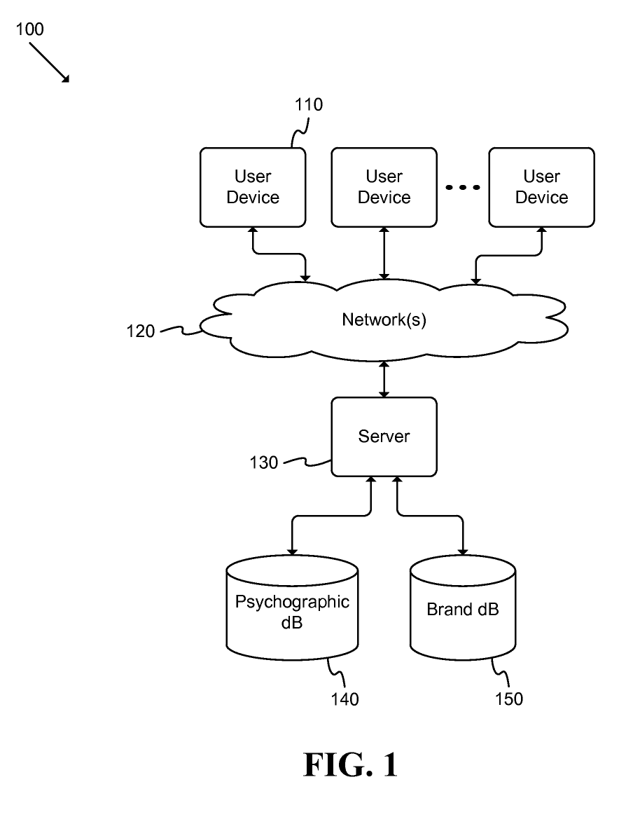

FIG. 1 illustrates a schematic block diagram of a conceptual system 100 provided by some embodiments. As shown, the system may include at least one user device 110, one or more networks 120 (and/or networks of networks such as the Internet), one or more servers 130, a psychographic database 140, and/or and brand database 150.

The user device 110 may be any appropriate device that is able to connect to a network (e.g., a smartphone, a tablet device, a personal computer or PC, etc.). The networks 120 may include various hardware and/or software elements that may allow multiple devices to communicate among each other. The server 130 may be a device capable of processing instructions and/or data. In addition, the server may be able to connect to a network. The psychographic dB 140 may include one or more devices adapted to store various psychographic data elements related to system users. The brand dB 150 may include one or more devices adapted to store various data elements related to brands (e.g., ads, products, graphics, slogans, etc.).

During operation, a consumer may operate a user device 110 to access a website, execute an application, etc. The user device may send and/or receive various communications across the networks 120. For instance, a user may manipulate a web browser in order to access a web site. As another example, a user may interact with a mobile device application to access some service. The user device 110 may interact with one or more servers 130 (and/or any associated storages 140-150) across the networks 120 in order to provide various features to the user.

Although system 100 has been described with reference to various specific details, one of ordinary skill in the art would recognize that the system may be implemented in various different ways without departing from the spirit of the invention. For instance, different embodiments may include additional elements, fewer elements, and/or different elements. In addition, various elements may be combined in some embodiments and/or various elements may be divided in some embodiments. In some embodiments, various databases may be made available across one or more networks through the use of an API and/or other appropriate interface (e.g., user device applications may be able to access various system databases using an API).

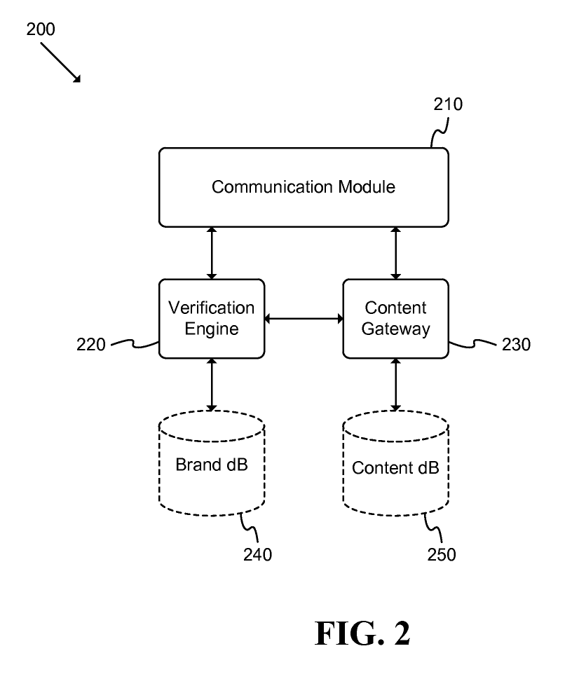

FIG. 2 illustrates a schematic block diagram of a conceptual software system 200 provided by some embodiments. As shown, the system may include a communication module 210, a verification engine 220, a content gateway module 230, and may have access to a brand dB 240 and/or a content dB 250.

The communication module 210 may be adapted to communicate among various user devices (e.g., devices 110), servers (e.g., servers 130), and/or other appropriate devices across one or more networks (e.g., networks 120). In some embodiments, the communication module 210 may include one or more APIs.

The verification engine 220 may be adapted to receive user input data and determine whether the received data matches some evaluation criteria to allow access to restricted content. The content gateway 230 may be adapted to provide content to a user through the communication module 210.

The brand dB 240 may include various ad and/or brand-related data, such as ad content, evaluation criteria, etc. The content dB 250 may include various content elements (e.g., text elements, video elements, multimedia elements, etc.).

During operation, a user may operate a user device to access, for instance, some content provided through a web site. The web site may communicate with the communication module 210 to determine whether the user is authorized to access the content. The communication module may send a query to the verification engine 220, which may, in turn, respond with a message indicating whether or not the user is authorized.

If the message indicates the user is authorized, the verification engine and/or communication module 210 may send a message to the content gateway 230 indicating that the user is authorized to access the content. The gateway may, in turn, facilitate access of the content from the content dB 250 to the communication module 210 and, in turn, a user device.

Alternatively, if the message indicates the user is not authorized, the verification engine 220 and/or communication module 210 may send a message to the content gateway 230 indicating that the user is not authorized to access the content. The gateway may then, in turn, not allow access of the content from the content dB 250 to the communication module 210 (and thus a user device and user).

Although system 200 has been described with reference to various specific details, one of ordinary skill in the art would recognize that the system may be implemented in various different ways without departing from the spirit of the invention. For instance, different embodiments may include additional elements, fewer elements, and/or different elements. In addition, various elements may be combined in some embodiments and/or various elements may be divided in some embodiments.

### II. Methods of Operation

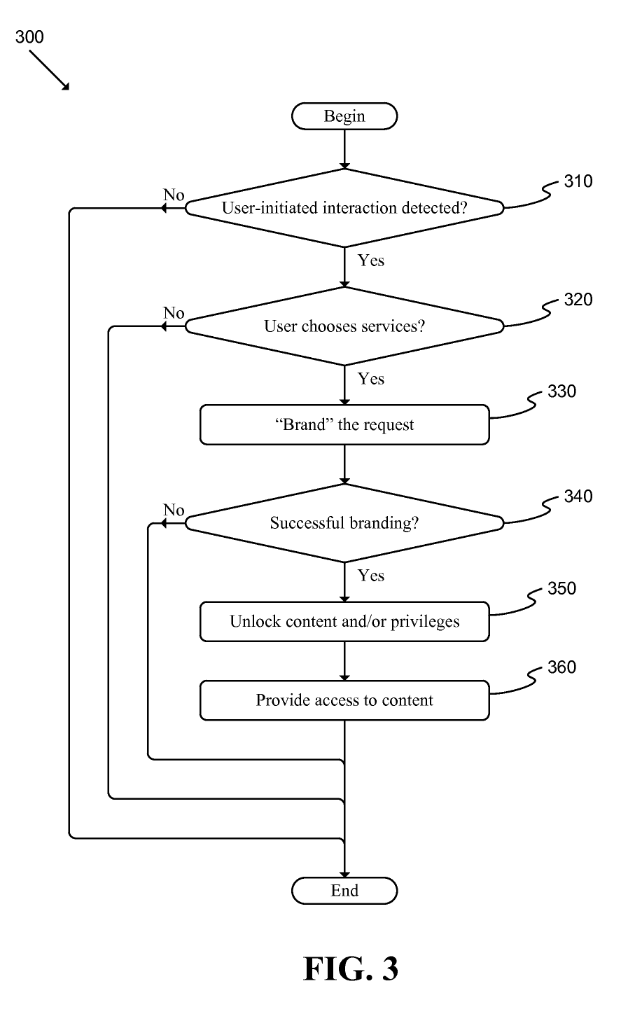

FIG. 3 illustrates a conceptual flow chart of a user engagement process 300 of some embodiments. Such a process may begin, for instance, when a user accesses a particular web site, application, etc.

Next, the process may determine (at 310) whether any user-initiated interaction (and/or other appropriate interaction) has been detected. Such a determination may be made in various appropriate ways. For instance, some embodiments may receive a request for access to content and/or data (e.g., when a user clicks a web link, when a user downloads an application, when a user accesses a game or other application, etc.).

If the process determines (at 310) that no interaction has been detected, the process may end. Otherwise, the process may next determine (at 320) whether a user chooses to engage the services provided by some embodiments. Such a determination may be made in various appropriate ways (e.g., based on one or more user selections, based on data associated with the user, etc.).

If the process determines (at 320) that the user does not choose to engage the services, the process may end. Alternatively, the process may next “brand” (at 330) the request (e.g., by providing one or more slogans, phrases, etc. to the users). The process may then determine (at 340) whether the branding was successful (e.g., by determining whether the user has entered the slogan correctly).

If the process determines (at 340) that the branding was not successful the process may end. Otherwise, the process may unlock (at 350) content and/or privileges available to the user and then provide (at 360) access to the content and/or privileges.

In some embodiments, providing access may involve sending a confirmation message or other appropriate data to the content provider such that the user may be allowed to access the content. The confirmation message or data may include an indication of the selected brand. Such an indication may be used by the content provider to change the presentation of the content based on the brand selection. For instance, in some embodiments a floating brand watermark may be provided (e.g., by placing the watermark in the bottom right corner of a web page with premium content). Such a watermark may include a uniform resource locator (“URL”), and/or other appropriate data, that may direct a user to resources associated with the brand (e.g., a web page, a multimedia presentation or other document, video content, etc.).

In addition, some content providers may typically include advertising in spaces surrounding the content (e.g., a column or article may be surrounded by various banner ads, text ads, etc.). Such content providers may, based at least partly on the brand selection, provide a customized set of advertisements, when appropriate (e.g., when a user selects a particular brand/slogan in order to gain access to a web page with premium content, all advertising on the page may be related to the brand).

One of ordinary skill in the art will recognize that process 300 may be implemented in various different ways without departing from the spirit of the invention. For instance, the various operations may be omitted, various additional operations may be performed, the operations may be performed in a different order, etc. In addition, the process may be performed as a part of a macro process or may be divided into various sub-processes. Furthermore, the process may be performed under various appropriate circumstances (e.g., the process may be repeated at various intervals, may be performed continuously, etc.).

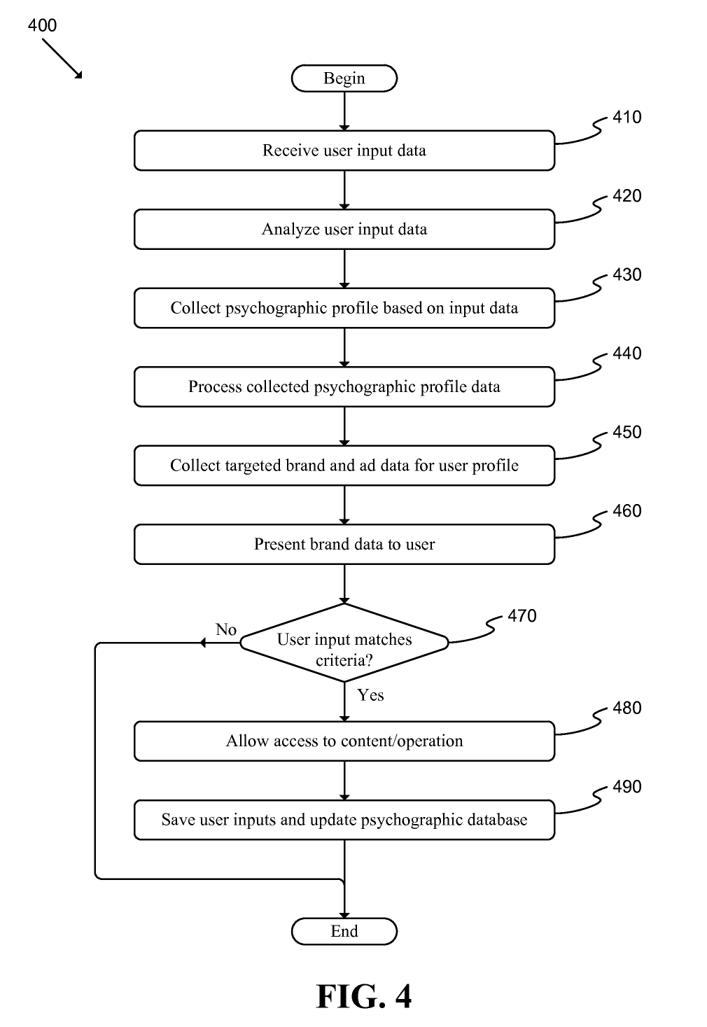

FIG. 4 illustrates a conceptual flow chart of a user branding process 400 of some embodiments. Such a process may begin, for instance, when a user initiates an interaction with web content that is provided through some embodiments (e.g., by clicking a web link).

Next, the process may receive (at 410) user input data. Such user input data may include various data elements associated with a user (e.g., location, age, gender, interests, etc.). The process may then analyze (at 420) the user data. Such analysis may be performed in various appropriate ways using various appropriate devices.

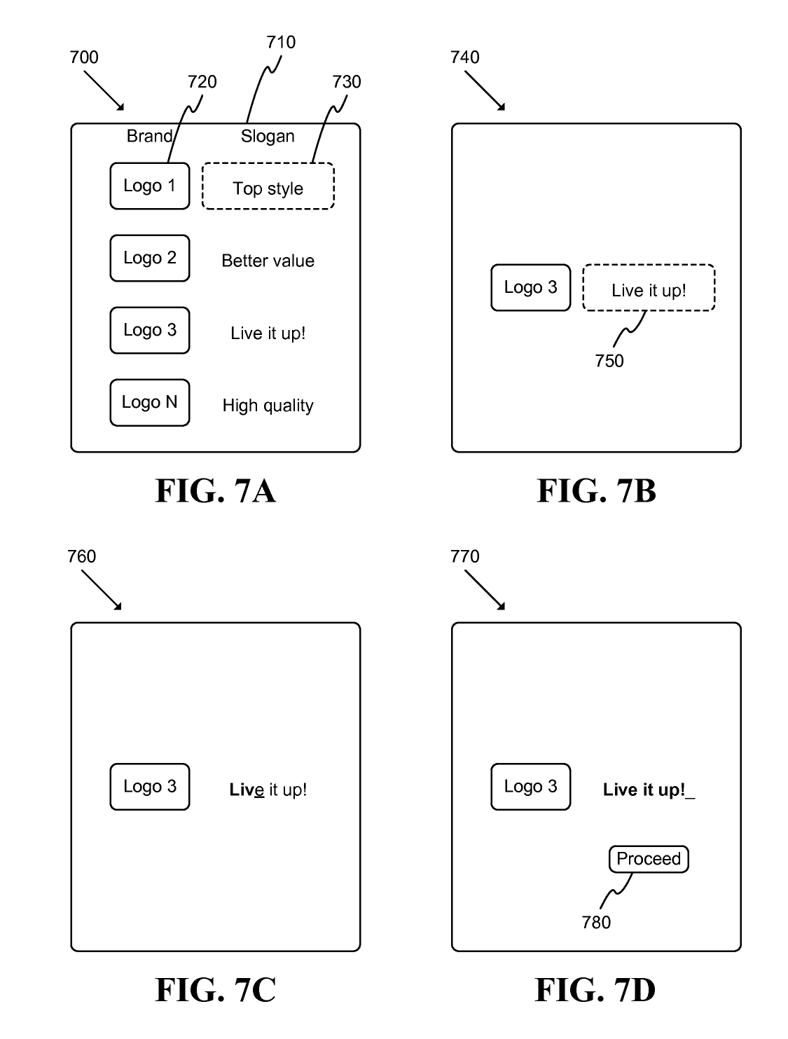

The process may then collect (at 430) psychographic profile information based on the user input data. Next, the process may process (at 440) the collected psychographic profile data. The process then may collect (at 450) targeted brand and ad data for the user profile. The process may then present (at 460) the brand data to the user. Such presentation may occur in various appropriate ways, for instance as described below in reference to FIGS. 7A-7D.

The process may then determine (at 470) whether a user input matches some criteria. In some cases, a user may be asked to enter a slogan, keyword, and/or other text-based data. The data entered by the user may then be compared to some expected data to determine whether the user has matched the provided data to a sufficient level. One of ordinary skill in the art will recognize that such data may be entered in various appropriate ways (e.g., text-based, audio entry, video entry, motion-based data entry, etc.).

If the process determines (at 470) that the user input does not match the criteria the process may end. Alternatively, the process may allow (at 480) access to the content and/or operations, save (at 490) user inputs and update the psychographic database and then end.

One of ordinary skill in the art will recognize that process 400 may be implemented in various different ways without departing from the spirit of the invention. For instance, the various operations may be omitted, various additional operations may be performed, the operations may be performed in a different order, etc. In addition, the process may be performed as a part of a macro process or may be divided into various sub-processes. Furthermore, the process may be performed under various appropriate circumstances (e.g., the process may be repeated at various intervals, may be performed continuously, etc.).

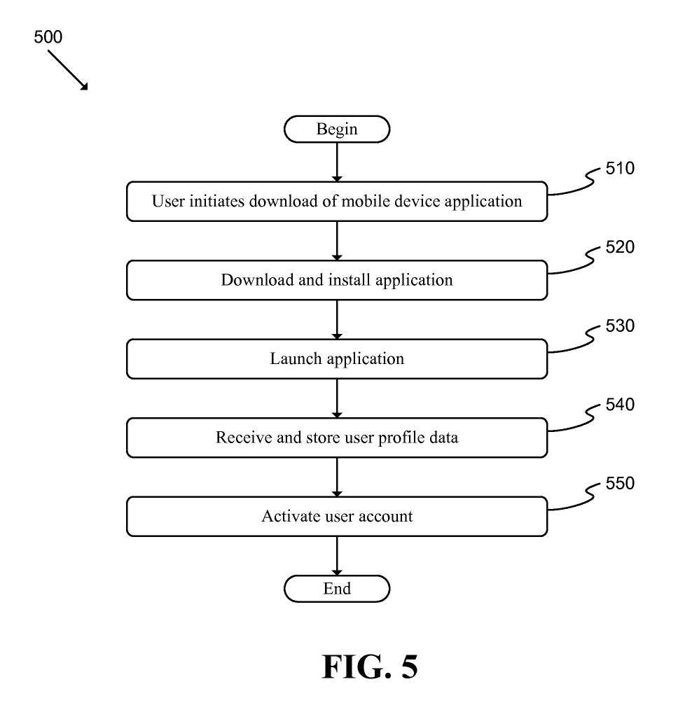

FIG. 5 illustrates a conceptual flow chart of a mobile download and account setup process 500 of some embodiments. Such a process may begin, for instance, when a user accesses an application store or other appropriate venue.

Next, a user may initiate (at 510) download of a mobile device application provided by some embodiments. The user may then download and install (at 520) the application. The user may then launch (at 530) the application, which will receive and store (at 540) user profile data and activate (at 550) a user account.

One of ordinary skill in the art will recognize that process 500 may be implemented in various different ways without departing from the spirit of the invention. For instance, the various operations may be omitted, various additional operations may be performed, the operations may be performed in a different order, etc. In addition, the process may be performed as a part of a macro process or may be divided into various sub-processes. Furthermore, the process may be performed under various appropriate circumstances (e.g., the process may be repeated at various intervals, may be performed continuously, etc.).

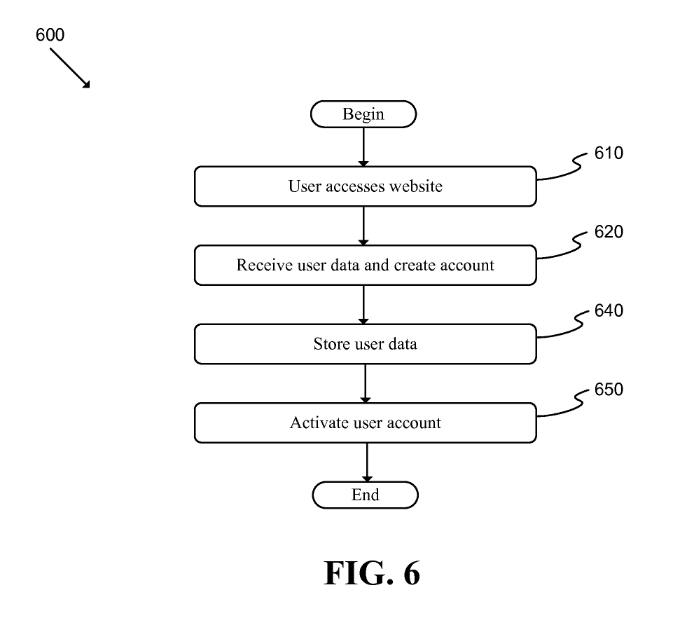

FIG. 6 illustrates a conceptual flow chart of a default account setup process 600 of some embodiments. Such a process may begin, for instance, when a user launches a mobile device application of some embodiments.

Next, a user may access (at 610) a website associated with a system of some embodiments. Next, the process may receive (at 620) user data and create a user account, store (at 640) the user data, and activate (at 650) the user account.

One of ordinary skill in the art will recognize that process 600 may be implemented in various different ways without departing from the spirit of the invention. For instance, the various operations may be omitted, various additional operations may be performed, the operations may be performed in a different order, etc. In addition, the process may be performed as a part of a macro process or may be divided into various sub-processes. Furthermore, the process may be performed under various appropriate circumstances (e.g., the process may be repeated at various intervals, may be performed continuously, etc.).

### III. Example GUIs

FIGS. 7A-7D illustrate a set of example GUIs provided by some embodiments. FIG. 7A illustrates a GUI 700 that includes an interaction area 710 that may be displayed before a user is allowed to access protected content. Such an interaction area may be optimized based on the user device (e.g., the area may have a certain shape and/or size when viewed on a PC monitor and another shape and/or size when viewed on a smartphone). As shown, the interaction area 710 may include a listing of one or more brand logo icons 720 (and/or other identifier(s)) and one or more slogans 730 and/or other branding items.

Each brand logo icon 720 may include graphics, text, etc. that relates to a brand. In some embodiments, each brand logo icon defines an area that may be selected by a user (e.g., by clicking a mouse, making a selection on a touch screen, etc.) in order to select the brand associated with the brand logo icon. Each slogan 730 may include a string of text that may be able to be entered by a user using standard devices (e.g., a keyboard, touch screen entry, etc.).

Each brand entry in the listing may be associated with the content and/or the user. For instance, when the user is attempting to access a particular type of content (e.g., sports, music, etc.), the brands may be associated with those fields (e.g., sports-related brands, music brands, etc.).

FIG. 7B illustrates a GUI 740 with a brand entry feature 750 provided by some embodiments after a user has selected an entry from the listing of FIG. 7A. Such a selection may be made in various appropriate ways (e.g., by clicking a logo icon 720, by clicking within the slogan area 730, etc.).

FIG. 7C illustrates another GUI 760. In this example, the user has begun typing the provided brand slogan (typed characters are shown in bold and current cursor position is underlined). Such a slogan may be displayed, for instance, as a string of semi-translucent (or gray-scale) text that a user may be able to type over such that the user does not have to remember the slogan or refer to a separate source while entering a response. As another example, the slogan may be displayed in a first area and the user may type the slogan in a second area. In some embodiments, a user may enter the response in various different ways (e.g., voice recognition, a cut-and-paste operation, etc.).

FIG. 7D illustrates a GUI 770 provided by some embodiments after a correct response has been entered by the user. In this example, once the response matches the slogan of the selected brand, a confirmation feature 780 is displayed. The user may then be able to activate the confirmation button (or other appropriate element) in order to validate access to the gated content. Alternatively, once the slogan has been correctly entered the user may automatically be redirected to the premium content without have to activate and confirmation.

During operation, a user may attempt to access protected content, at which point the GUI 700 may be displayed. The user may then select a brand from the listing (alternatively, the user may proceed with a default selection or a selection based on historical data associated with the user), causing GUI 740 to be invoked. Next, as shown in GUI 760, the user may enter the slogan associated with the selected brand. Entering the slogan correctly may invoke GUI 770. The user may then click the confirmation button 780 to verify the entry. When the entry matches the selected slogan, the user may then be able to access the protected content. Alternatively, if the entry does not match the selected slogan, the user may be denied access to the content.

One of ordinary skill in the art will recognize that although the GUIs of FIGS. 7A-7D have been described with reference to various specific details, different embodiments may be implemented in various different ways without departing from the spirit of the invention. For instance, different embodiments may include different numbers of elements, different specific interaction elements, different graphics and/or presentation elements, etc. In addition, various different user operations may be associated with various different interactions (e.g., a user may type information on a keyboard, make selections using a mouse, manipulate the GUIs through a touch screen interface, etc.).

In addition, various other GUIs may be used in conjunction with content pages (e.g., a brand watermark, selective advertising, etc.). Furthermore, various GUI elements may be optimized for use by particular devices (e.g., the size and shape of logos, entry areas, selection elements, etc. may be varied among different types of devices and/or among different devices of a particular type, etc.).

### IV. Computer System

Many of the processes and modules described above may be implemented as software processes that are specified as at least one set of instructions recorded on a non-transitory storage medium. When these instructions are executed by one or more computational element(s) (e.g., microprocessors, microcontrollers, Digital Signal Processors (“DSP”), Application-Specific ICs (“ASIC”), Field Programmable Gate Arrays (“FPGA”), etc.) the instructions cause the computational element(s) to perform actions specified in the instructions.

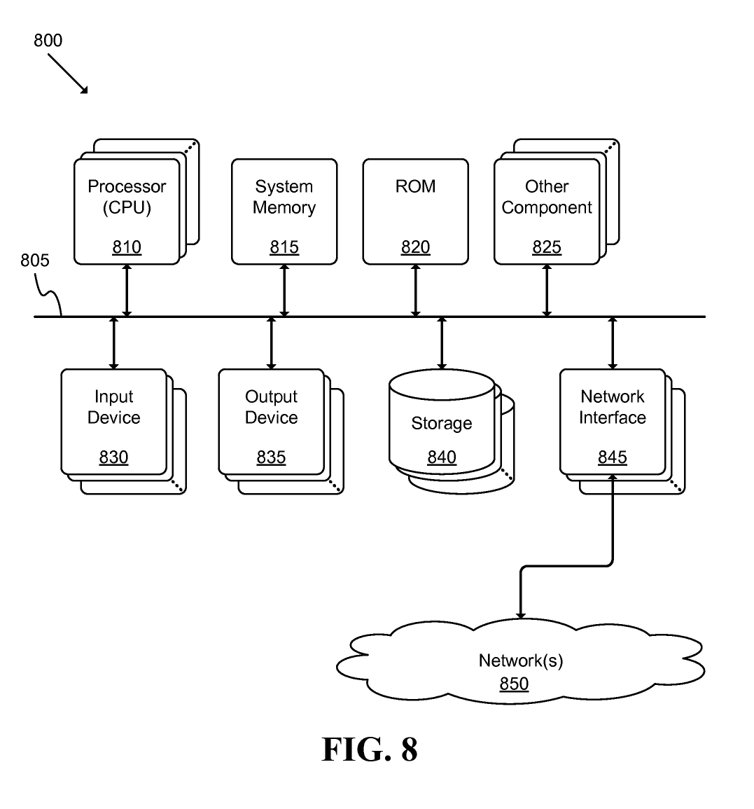

FIG. 8 conceptually illustrates a schematic block diagram of a computer system 800 with which some embodiments of the invention may be implemented. For example, the system described above in reference to FIG. 1 may be at least partially implemented using computer system 800. As another example, the processes described in reference to FIGS. 3-6 may be at least partially implemented using sets of instructions that are executed using computer system 800.

Computer system 800 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 800 may include a bus 805, at least one processing element 810, a system memory 815, a read-only memory (“ROM”) 820, other components (e.g., a graphics processing unit) 825, input devices 830, output devices 835, permanent storage devices 840, and/or network interfaces 845. The components of computer system 800 may be electronic devices that automatically perform operations based on digital and/or analog input signals.

Bus 805 represents all communication pathways among the elements of computer system 800. Such pathways may include wired, wireless, optical, and/or other appropriate communication pathways. For example, input devices 830 and/or output devices 835 may be coupled to the system 800 using a wireless connection protocol or system. The processor 810 may, in order to execute the processes of some embodiments, retrieve instructions to execute and data to process from components such as system memory 815, ROM 820, and permanent storage device 840. Such instructions and data may be passed over bus 805.

ROM 820 may store static data and instructions that may be used by processor 810 and/or other elements of the computer system. Permanent storage device 840 may be a read-and-write memory device. This device may be a non-volatile memory unit that stores instructions and data even when computer system 800 is off or unpowered. Permanent storage device 840 may include a mass-storage device (such as a magnetic or optical disk and its corresponding disk drive).

Computer system 800 may use a removable storage device and/or a remote storage device as the permanent storage device. System memory 815 may be a volatile read-and-write memory, such as a random access memory (“RAM”). The system memory may store some of the instructions and data that the processor uses at runtime. The sets of instructions and/or data used to implement some embodiments may be stored in the system memory 815, the permanent storage device 840, and/or the read-only memory 820. Other components 825 may perform various other functions.

Input devices 830 may enable a user to communicate information to the computer system and/or manipulate various operations of the system. The input devices may include keyboards, cursor control devices, audio input devices and/or video input devices. Output devices 835 may include printers, displays, and/or audio devices. Some or all of the input and/or output devices may be wirelessly or optically connected to the computer system.

Finally, as shown in FIG. 8, computer system 800 may be coupled to a network 850 through a network interface 845. For example, computer system 800 may be coupled to a web server on the Internet such that a web browser executing on computer system 800 may interact with the web server as a user interacts with an interface that operates in the web browser.

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 800 may be used in conjunction with the invention. Moreover, one of ordinary skill in the art will appreciate that many other system configurations may also be used in conjunction with the invention or components of the invention.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the invention has been described with reference to numerous specific details, one of ordinary skill in the art will recognize that the invention can be embodied in other specific forms without departing from the spirit of the invention. For example, several embodiments were described above by reference to particular features and/or components. However, one of ordinary skill in the art will realize that other embodiments might be implemented with other types of features and components. One of ordinary skill in the art would understand that the invention is not to be limited by the foregoing illustrative details, but rather is to be defined by the appended claims.

We claim:

1. A system adapted to manage user access to media content, the system comprising:
a communication module adapted to receive a user request to access content;
a verification engine communicatively coupled to the communication module, the verification engine adapted to provide a query to a user and receive an associated response; and
a content gateway communicatively coupled to the verification engine and the communication module, the content gateway adapted to provide content to the user if the verification engine determines that the response satisfies the query.

2. The system of claim 1 further comprising:
a brand database adapted to store data related to a brand; and
a content database adapted to store media content.

3. The system of claim 2, wherein the media content includes premium content that is not accessible to the general public.

4. The system of claim 1, wherein the communication module is adapted to receive the user request over at least one network connection.

5. The system of claim 1, wherein the query comprises a first string of text, the response comprises a second string of text, and the response satisfies the query when the first string of text matches the second string of text.

6. The system of claim 1 further comprising a third-party database adapted to store media content.

7. The system of claim 6, wherein the third-party database is communicatively coupled to the content gateway over at least one network connection.

8. An automated method adapted to control user access to web-based content, the method comprising:
identifying a user interaction;
providing a branding request;
receiving a response to the request; and
providing access to the content if the response matches a set of evaluation criteria.

9. The automated method of claim 8, wherein identifying a user interaction comprises determining that a user has navigated to a particular item of web-based content.

10. The automated method of claim 8, wherein providing a branding request comprises displaying at least one phrase associated with at least one brand.

11. The automated method of claim 10, wherein receiving a response to the request comprises receiving a text-based user input.

12. The automated method of claim 11, wherein the evaluation criteria comprises a text-based reference.

13. The automated method of claim 8, wherein the web-based content comprises at least one of text-based content, video content, audio content, and multimedia content.

14. The automated method of claim 8, wherein the branding request comprises a selectable set of brand logos, each logo having an associated phrase.

15. A non-volatile storage medium comprising sets of instructions that, when executed by a processing device, provide a graphical user interface (GUI) adapted to facilitate access to premium content, the GUI comprising:
a listing of brands comprising a set of selectable elements, each selectable element comprising at least one graphical display element and at least one text-based phrase;
a brand entry feature associated with at least selectable element, the brand entry feature adapted to receive a text-based user entry; and
a confirmation feature adapted to allow a user to proceed to the premium content based at least partly on the text-based user entry.

16. The non-volatile storage medium of claim 15, wherein each graphical display element comprises a logo.

17. The non-volatile storage medium of claim 15, wherein the brand entry feature is invoked if a user selects an element from the set of selectable elements.

18. The non-volatile storage medium of claim 17, wherein the confirmation feature is invoked if the text-based user entry matches to text-based phrase.

19. The non-volatile storage medium of claim 17, wherein the brand entry feature comprises a display of the text-based phrase.

20. The non-volatile storage medium of claim 19, wherein the brand entry feature further comprises a display of the text-based user entry.
